(19) United States
(12) Patent Application Publication
(10) Pub. No.: US 2026/0346629 A1
(43) Pub. Date: Nov. 5, 2026

(54) PANEL-SHAPED WORKPIECE WITH EDGE DECOR MATCHING MAIN SURFACE DECOR

(71) Applicant: Unilin, BV, Wielsbeke (BE)

(72) Inventors: Thomas Deruyter, Wielsbeke (BE); Benjamin Clement, Wielsbeke (BE)

(73) Assignee: Unilin. BV, Wieslsbeke (BE)

(21) Appl. No.: 19/487,212

(22) PCT Filed: Jun. 11, 2024
(86) PCT No.: PCT/IB2024/055681

§ 371 Date: Nov. 24, 2025

Related U.S. Application Data
(60) Provisional application No. 63/509,533, filed on Jun. 22, 2023.
(60) Provisional application No. 63/581,990, filed on Sep. 12, 2023.

(51) Int. Cl. B41M 5/00

(52) U.S. Cl. CPC B41M 5/0076

(57) ABSTRACT

A panel-shaped workpiece (10) and a method for manufacturing such panel-shaped workpiece (10), comprises providing a panel unit (1) comprising two opposing main surfaces and side edges (3a, 3b, 3c, 3d), wherein at least one of said main surfaces is a decorative main surface (5) comprising a first decor and wherein the method comprises a decoration step in which side edges (3a, 3b, 3c, 3d) are provided with a decoration comprising a second decor, wherein the second decor matches the first decor, said decoration step comprising—a first partial step wherein an inspection device (6) acquires data of said panel unit (1);—a second partial step wherein said second decor is derived from said data.

The present disclosure relates to a method for manufacturing a panel-shaped workpiece, such as a countertop, wherein the method comprises the step of providing a panel unit comprising two opposing main surfaces and side edges connecting said two opposing main surfaces, wherein at least one of said main surfaces is a decorative main surface comprising a first decor and wherein the method comprises a decoration step in which at least a part of one of said side edges is provided with a decoration comprising a second decor, to form a decorative side edge, wherein the second decor matches the first decor. This invention also relates to such a panel-shaped workpiece.

The panel-shaped workpiece can be a countertop/worktop, such as a kitchen countertop or a bathroom worktop or a table top or a reception countertop. The panel-shaped workpiece can also be a furniture panel and/or a door panel and/or a stair panel. Such panel-shaped workpieces comprise two opposing main surfaces of which at least one is decorative, and side edges which connect said two opposing surfaces. One, two or more of side edges, even all of said side edges, can be visible. It is important that said visible side edges have a good visual appearance. Said panel-shaped workpieces often imitate natural products, such as solid wood, natural stone countertops/worktops—for example marble slabs or granite slabs—. To give the impression of solid wood countertops/worktops or natural stone countertops/worktops, it is of importance that the visible side edges match the look and feel of the at least one decorative main surface. However, with existing panel-shaped workpieces, it is often directly visible to the eye that the matching between the decorative side surface and the visible side edges is inferior. For example there can be color differences between the decorative main surface and the visible side edges, and/or distinctive features, such as veins or wood knuts, abruptly stop at the transitions between the decorative main surface and the visible side edges, such that is visible that the panel-shaped workpiece is an imitation of for example natural stone/solid wood.

These panel-shaped workpieces are often cut from a bigger base panel. An edge band can be more or less suitable to cover up a side edge of one workpiece that has been cut out from a said bigger base panel in an aesthetic manner, however said edge band can be less suitable for a side edge of another workpiece that has been cut out from the same base panel.

There is a need for improved methods for manufacturing panel-shaped workpieces.

The invention, according to a first aspect, relates to a method for manufacturing a panel-shaped workpiece, such as a countertop, wherein the method comprises the step of providing a panel unit comprising two opposing main surfaces and side edges connecting said two opposing main surfaces, wherein at least one of said main surfaces is a decorative main surface comprising a first decor and wherein the method comprises a decoration step in which at least a part of one of said side edges is provided with a decoration comprising a second decor, to form a decorative side surface, wherein the second decor matches the first decor, wherein said decoration step comprises
a first partial step wherein an inspection device acquires data of said panel unit, for example acquires at least an image of said first decor;
a second partial step wherein said second decor is derived from said data and said decoration comprising said second decor is provided upon said side edge.

By deriving said second decor from said data, it can be ensured that the second decor matches the first decor. With matching is indicated that there is at least some resemblance between the first decor and the second decor, such that at first sight or glancing at the workpiece or taking a quick look of the workpiece, one might think that said workpiece is a natural product, such as solid wood or a stone slab, for example marble or granite. For example the base color(s) of the first decor can match the base color(s) of the second decor. For example, if the first decor resembles long grain, a said second decor can resemble end grain or similar long grain. Preferably the match is as such that said first decor continues in said second decor in such a way that some visual elements, which are visible in the first decor, continue almost uninterruptedly in the second decor and the impression of for example solid wood or stone slabs is created. This is possible with this method, because said second decor is derived from said data, such that for every panel unit, one can match the second decor as desired to the first decor. With this method, it is possible to obtain a decorative side surface that not only has some resemblance with the decorative main surface, but looks like the side surface of a panel-shaped workpiece made from a wood or stone, even upon closer inspection.

This data of said panel unit is preferably panel unit specific data. This panel unit specific data could comprise one or more of the following non-exhaustive list: one or more images of (portions of) the first decor (of which some images could be overlapping), data from (computer-readable) codes—for example QR codes, EAN-codes, RFID tags, watermarks, holograms, strips, micro-lettering, fluorescent portions, barcodes—, data relating to the base panel and/or data relating to the position of said panel unit in said base panel in case said panel unit is taken from a bigger base panel, data relating to the position of the end grain and the long grain if the first decor is a wood decor, data relating to the dimensions of panel unit—for example the dimensions of said side surfaces—, data relating to the texture of the decorative main surface. A said computer-readable code can provide a link to digital data stored on the at least one computer storage media. With panel unit specific data, one can match the second decor thoroughly with the first decor. For example one can go beyond only matching the base color(s) of the first decor and the second decor, one could also match distinctive visual elements, such as veins of stone decor or veins, knuts, etc. of wood decor, to each other and/or if the first decor is a wood decor, one can provide a natural looking matching end grain or long grain for the second decor.

Said panel unit comprises two opposing main surfaces wherein at least one of said main surfaces is a decorative main surface. If only one said main surface is visible, for example for kitchen or bathroom countertops, only one main surface needs to be decorative. If two main surfaces are visible, then preferably both the main surfaces are decorative main surfaces comprising respectively the first decor and a third decor. The first decor and the third can or cannot be identical. When providing said second decor, it is desired that the second decor also matches the third decor, however this is not obliged. If there is a third decor, data of said third decor can be acquired in the first partial step and this to ensure that the second decor matches the third decor. For example one or more images can be acquired from the third decor.

The panel shaped unit has side edges. Only the visible side edges need to be decorative side edges. In this method one or more side edges can be provided with a said second decor. This can be done at least partially simultaneously and/or at least partially consecutively. For example if the panel unit is rectangular shaped with a first pair of opposing side edges and a second pair of opposing side edges, one can firstly provide a said decoration comprising a second decor upon the first pair of opposing edges and consecutively one can provide a said decoration comprising a second decor upon said second pair of opposite edges. The decorative side edges can be straight and/or flat, rounded (e.g., convex), beveled and/or angled, or profiled (e.g. such as a bullnose or an ogee). Preferably the entire outer surface of the decorative side edges is provided with a decor. For example if the decorative side edges are rounded, beveled and/or angled, also the rounded parts, the bevels and/or the angled parts are provided with a decor.

The panel shaped unit has side edges. At least one of said side edges can already comprise a decorative side surface and can thus already be a decorative side edge with a decor, said decor preferably matching the first decor of the decorative main surface. For example the panel shaped unit can be sawn or otherwise obtained from a bigger rectangular plate comprising at least one decorative surface. At least one side edge of said bigger plate, or at least two opposing side edges of said bigger plate can be decorative side edges or all side edges of said bigger plate can be decorative side edges. For example said side edges can already comprise matching edge band. When the panel unit is obtained from a said bigger plate, some of said side edges can already be decorative side edges, for example comprise said matching edge band. During the method according to the invention, then only the visible side edges that are not decorative side edges, have to be provided with said decoration comprising the second decor, for example have to be provided with edge band, said edge band then comprising or being provided with said second decor. The benefit here is that one can easily provide the side edges of the bigger panel with matching edge band, since the decor of the bigger panel is predetermined and this in contrast to the first decor, which depends on the position of the panel unit within the bigger plate.

The panel shaped unit has side edges. At least one of said side edges can already comprise an edge band, said edge band being a white edge band or having a base color corresponding to the colors of the first decor or having a basic decor corresponding to the first decor. Here one can apply said decoration comprising said second decor upon said edge band. Of course such a white edge band or an edge band having a base color corresponding to the colors of the first decor and/or having a basic decor corresponding to the first decor, can also be provided during the decoration step.

The second decor and/or the first decor can or cannot be a textured decor. With a textured decor is indicated a decor comprising a 3D relief.

A said edge band can made from different materials, for example can be chosen from the group of: ABS (acrylonitrile butadiene) or HPL (high pressure laminate) comprising for example resin and paper layers-for example comprising at least a resin impregnated transparent or translucent paper layer, a resin impregnated (digitally) printed paper layer, and one or more resin impregnated kraft papers-or PP (polypropylene).

Acquiring data can be done while the panel unit is transported on a transporting device, such as a chain transporting device or similar, and this for example along the inspection device. The advantage here is that the first partial step and the second partial step can be easily done in the same continuous process. For example the panel shaped unit can be transported alongside the inspection device and can further along the transporting device be provided with said decoration.

Acquiring data can also be done while the panel unit is kept stationary and/or when the panel unit has been placed in an inspection device, and this for example with a separate inspection device. With a separate inspection device the different steps of the decoration step can be easily performed with different machines and even in different places. For example, a cabinet-maker such as a kitchen maker, can make countertops and this by sawing panel units from bigger plates. The panel units of which some side edges need to be provided with a decoration to form a decorative side edge, can then inspected by the inspection device to acquire data of said panel unit. Said data can be delivered to another party, said party for example making edge band on the basis of said data, thus making custom-made edge band. The cabinet-maker can then appropriately attach said custom-made edge band to the said side edges.

The first partial step and the second partial step of the decoration step can be performed consecutively. However this is not strict requirement. For example, there can be some overlap between the first partial step and the second partial step. This can be for example the case if the second partial step comprises actions which are performed independently from said data. For example the decoration step can have the action of gluing a basic edge band to a said side edge of the panel unit, and this followed by printing upon said edge band. For gluing said basic edge band, said data is not needed, only when printing upon said basic edge band said data is needed, such that it is know what needs to be printed upon the basic edge band to obtain said second decor.

Preferably said inspection device at least acquires data of the first decor of said panel unit, for example acquires an image of said first decor and/or acquires data by scanning said first decor. Since it is desired to match the second decor to the first decor, data of the first decor is very suitable for this. For example the inspection device can comprise a camera or multiple cameras to take one or more images of said first decor. Acquiring images and/or scanning can be done inline, for example while the panel unit is transported by a first transporting device. Further preferably the decoration is then provided upon the side edge while the panel unit is transported by the first transporting device or by a transporting device downstream of said first transporting device. Said image can be an image of a portion of the first decor.

The second decor can
comprise a portion of the first decor, or an adjustment, a skewing, or another alteration thereof; and/or
can be a mirror-image of a portion of the first decor, or a portion, an adjustment, a skewing, or another alteration thereof.

Preferably the inspection device acquires at least two images of said first decor, wherein preferably said two images are partially overlapping, wherein said second decor is at least derived from said images. By having overlapping images, the second decor can be very accurately matched to the first decor.

If the first partial step comprises acquiring an image, then one or more of the following can be present:
acquiring/having a master file associated with the first decor disposed on the main surface, wherein the master file comprises data upon which the first decor disposed on the main surface is based and/or data upon which the second decor to be provided upon the side edge is based;
deriving said second decor comprises: identifying a first portion of the image corresponding to a portion of the first decor that will be used; and identifying a second portion of the image corresponding to a portion of the first decor adjacent to the first portion, wherein the second decor is based upon the second portion of the image;
deriving the second decor is based upon the evaluation of the image, and this is performed by a machine-learning model, wherein the machine-learning model is for example configured to identify a feature within the image corresponding to a feature within the first decor and wherein the machine-learning model is configured to predict a related feature for the second decor based upon the feature identified within the image;
the second decor is a mirror-image of a portion of the first decor adjacent said side edge.

In a very preferred embodiment the second decor abuts the first decor in such a way that the first decor continues in the second decor, such that visual elements of the first decor, for example wood veins if the first decor is a wood decor or veins if the first decor is a stone decor, continue in the second decor. When having a first decor which imitates natural products such as wood or stone—for example marble or granite—, there will be visual elements at the height of the transition between the first decor and the second decor. In natural products these visuals elements will continue at the edges, such that it is important that these visuals elements of the first decor transit almost seamlessly in the second decor, thus continue in the second decor. For first decors having a wood decor, one needs to take into account an additional aspect, namely that solid panels have surfaces with end grain, long grain or other grain types. For example if the decorative main surface resembles long grain, some side edges will also have to resemble long grain, while other side edges will have to resemble end grain. With this method, this is possible.

In a specific embodiment the panel unit, for example the first decor, comprises at least one code which is readable by the inspection device, wherein, to acquire said data the inspection device reads said code, and wherein preferably the inspection device comprises a scanner configured to read the at least one code. The code can be chosen from the non-exhaustive list of: QR codes, EAN-codes, RFID tags, watermarks, holograms, strips, micro-lettering, barcodes. The benefits of working with one or more codes is that additional data, such as data that cannot or is difficult to derive from for example an image, can be made available to form the second decor and this in an easy manner. For example information with regard to the pigments, dyes, coatings, lacquers, paints, resolution etc. used for the first decor, information about the side edges, for example the substrate of the panel shaped unit and/or possible treatment of the side edges and/or the presence of a certain edge band and/or the dimensions of the side edges. Also the position of a said at least one code in the panel unit can give information about the first decor, especially when the panel shaped unit is sawn or otherwise obtained from a bigger panel, since the position of the code can indicate the position of said first decor in said bigger panel. Said code is preferably a printed code and can be present in the first decor. Said code can also be present below the decorative main surface. For example said panel shaped unit can comprise a substrate and at least a top layer comprising said decorative main surface. Said code can then be present upon or in the substrate. To acquire said data, said inspection device can read the at least one code and can additionally take one or more images of the first decor.

Preferably said code is invisible to the eye, for example is invisible in the visible spectrum, such that the code does not negatively influence the appearance of the main decorative surface. For example the code can be invisible because it is located below the decorative main surface or because it is part of the main decorative surface but the human eye cannot perceive it, for example because it is not in the visible spectrum or it is not seen as a code—for example the code can be concealed within the first decor using steganographic methods—.

The panel unit can be obtained from a base plate, for example sawn from a base plate, said base plate comprising two opposite surfaces connected by edges, wherein at least one of said two opposite surface is a decorative surface comprising a base decor, wherein the first decor is a section of the base decor, and wherein the data comprises information with regard to the first decor, for example indicates the position of said first decor in base decor and/or indicates which part of the base decor is present. It is then known where said panel unit fits int the base plate. Without little complexity the first decor can be determined such that one can easily match the second decor to the first decor. For example one have a master file with possible base decors and optionally matching second decors for different positions of the side edges.

Further preferably use is made of a master file comprising data of possible base decors of the decorative surface, wherein the master file preferably further comprises data of matching second decors for each base decor, and wherein the second partial step makes use of said master file. Preferably the base decors are derived from solid wood/stone and further preferably said matching second decors are also derived from solid wood/stone. For example one can start from solid wood planks or plates, and cut/saw these plates to obtain information about possible edges to provide data of matching second decors. For example one can start from granite or marble slabs, and cut/saw them to obtain information about possible edges to provide data of matching second decors.

In a very preferred embodiment, deriving the second decor from the data, comprises evaluating said data and determining the required second decor based upon the evaluation of said data. For this use can or cannot be made of artificial intelligence.

Further preferably, evaluating the data and determining the second decor based upon the evaluation of the data, is at least partially performed by a machine-learning model. The invention also relates to a machine-learning model, wherein the machine-learning model is configured to receive an image of at least a portion of the first decor; evaluate the image; and determine the second decor, wherein the machine-learning model is preferably is configured to identify a feature within the image corresponding to a feature within the decor on the main surface and wherein further preferably the machine-learning model is configured to predict a related feature based upon the feature identified within the image. The invention also relates to a method of training a machine-learning model configured to receive an image of at least a portion of the first decor, to evaluate the image and, to determine the second decor based upon the evaluation of the image, the method comprising processing training data, wherein further preferably training data is related to surface ornamentation associated with a natural material, preferably, stone or wood, more preferably, granite or marble.

In a very preferred embodiment the first decor continuous in the second decor, for example continuous as follows:
the first decor comprises a first wood structure with straight grain and the second decor comprises a second wood structure with matching straight grain or matching end grain, wherein at the height of the transition between the decorative main surface and the decorative side surface, wood elements continue as such resembling solid wood, and this at least at the height of said decorative main surface and the decorative side edge;
the first decor comprises a first stone structure with veins, and the second decor comprises a second stone structure with veins, wherein veins at the height of the transition between the decorative main surface and the decorative side surface continue as such resembling true stone.

In a preferred embodiment the second partial step comprises one or more of the following:
applying a print receiving layer;
applying a print, for example to form a print layer, said print preferably comprising one or more inks;
applying a protection layer.

The above is a non-exhaustive list.

Here the print can form the second decor. Also the print layer together with the protection layer and/or the print receiving layer can form the second decor. It is also possible that the print receiving layer, the print layer and the protection layer form the second decor. Applying said print receiving layer can indicate one or more actions of the following non-exhaustive list:
applying one or more primers;
applying one or more coatings;
applying an edge band;
applying filling material.
applying one or more varnishes;
applying one or more lacquers;
texturing.

Also one or more of the above actions could also be not part of applying a print receiving layer, but could be referred to as a separate part of the second partial step. For example applying edge band can be seen as a separate part that is performed before applying said print receiving layer. Said edge band can form the print receiving layer as such or a primer/coating/varnish can be applied upon an edge band to form a print receiving layer. The edge band can be applied with a machine or can be applied manually.

Application of said primers/coatings/varnishes/lacquers/filling material can be digitally controlled, for example digitally printed. The application of said primers/coatings/varnishes/lacquers/filling material can be done over the same height as the side edge (or the height of the edge band if the panel unit comprises such edge band or an edge band has been applied to the side edge), or can be a few mm, for example 0.1 to 2 mm, larger, such as to ensure a good transition between the first and the second decor. Said primers/coatings/varnishes/lacquers/filling material can have a base color that matches the first decor and/or can be translucent/transparent. Said primers/coatings/varnishes/lacquers can be polyurethane or acrylic based and/or can be (UV) curable.

Preferably to provide the print, inks are used, said inks for example comprising the same pigments and/or colorants as the inks that have been used to form the first decor. Also preferably the resolution of the second decor is approximately the same as the resolution of the first decor. If use is made of a print receiving layer, and if to provide the print, inks are used, the print receiving layer can also be indicated as an ink receiving layer.

To provide said decoration comprising the second decor, digital printing is very suitable, since digital printing provides lots of flexibility with regard to colors, prints, inks, etc. However the side edge of a panel unit is not always suitable or is less suitable for digital printing. For example digital printing can make use of certain inks which cannot be applied in a good manner to the side edge as such. If the workpieces comprise a wood based substrate, such as particle board or a wood fiber board (for example MDF—medium density fiberboard—or HDF—high density board—), said wood based substrate is present at the side edges and said inks cannot be applied to it in an accurate manner without treating said side edges with primers and/or coatings and/or filing material and/or first attaching an edge band. Which actions are performed to form the print receiving layer will depend on the panel shaped unit, namely the material at the height of the side edges, the type of print and the type of protection layer. Applying the print is preferably done by digital printing, however analog printing is not excluded. Applying a protection layer will protect the print, and additionally it can give the second decor a texture if required, for example by digital structuring. If also a print receiving layer and/or edge band is applied or if said panel unit already comprises an edge band, said edge band and/or the print receiving layer can be textured, such that the second decor will also be a textured decor. Applying the print receiving layer can be done in different ways, for example, by applying a digital varnish to create positive structure, applying a digital mask on wet homogeneous applied varnish layer, cure said varnish and brush away mask after curing, apply a flexible varnish and emboss mechanical (by pressure) with for example a cylinder. Applying the ink can be done with single or multipass printing. Single-pass means that the printer comprises a stationary printing unit and that the side edge to be printed, in the context of this disclosure, moves along the printing unit. For instance, in particular, the printer may preferably comprise a plurality of printing units aligned along the moving direction, with each printing unit configured to print one ink. A printing unit, also often called a bar or a beam, can comprise one or more printing heads. Each printing unit preferably is dedicated to a specific color. Thus, the colors are sequentially printed on the basis of the sequence of the printing unit in the advancing direction. In some embodiments, preferably, the printing units, can be disposed at an angle or can be configured to be tilted relative to a supporting frame of the printer, in such a way to correctly perform the print on the side edge, especially when the latter is curved or inclined. This is very suitable for printing upon an edge band, more particular for printing upon an edge band which is rounded (e.g., convex), beveled and/or angled, or profiled, since this makes it very easy to also print upon the rounded parts, the bevels and/or the angled parts. Preferably also one or more printing units are present which can print upon the edge of the edge band which extends transversely to the longitudinal direction of the edge band. In some embodiments, the printer can also comprise a detecting means adapted to identify the incoming panel unit, in such a way that the second decor thoroughly matches the first decor. In some embodiments, to print upon the side edge, a said printing unit viewed in the plane of the panel unit, is positioned/made to operate at an angle of less than 90° to the relevant side edge. Further if the panel unit is moved along the printing unit, a said printing unit can positioned/made in such a way that it operates in a direction with a component which is opposite to the movement of the said panel unit or operates in a direction with a component which is parallel to the movement of the said panel unit.

Here below are some possible embodiments of the second partial step:
embodiment 1: apply a lacquer to form the ink receiving layer, print an ink to form the print layer, apply varnish to form the protection layer. Applying said ink and/or applying said varnish and/or applying said lacquer can be done digitally, for example by digital printing. Before forming said ink receiving layer, the side edge can already comprise an edge band or an edge band can be glued to the side edge.
embodiment 2: apply a varnish or lacquer upon an edge band, (digital) print said edge band with one or more inks and then glue said edge band to the side edge. Optionally a protection layer can be applied above said digital print.

If applying the protection layer and/or the ink receiving layer comprises applying a varnish/lacquer/coating, this can be done in many ways for example:
apply as a homogenous layer (digital or analog);
apply digitally to create a positive structure;
apply a digital mask on wet homogeneous applied varnish/lacquer/coating, wherein said mask prevents curing, then cure and brush away the mask after curing;
apply a flexible varnish/lacquer/coating and emboss mechanically (e.g. by pressure) with cylinder.

The print receiving layer and/or the protection layer can comprise one layer or can comprise two or more sublayers. The print can be made with one er several inks.

Applying said protection layer can indicate one or more actions of the following non-exhaustive list:
applying one or more primers;
applying one or more coatings;
applying one or more varnishes;
applying one or more lacquers;
texturing.

The protection layer can be transparent or translucent. Also, the protection layer can be either glossy or matt. The protection layer may be effective to provide mechanical, physical, and chemical resistance to the decorative side edge. In particular, the protection layer may be effective to provide resistance against scratches and chemical attack.

In a preferred embodiment not only the first and the second decor are matching, also the gloss is matched, this for example by using matting agents in the varnish and/or by using excimer curing, when a curable varnish/lacquer/coating is used to form the protection layer and/or print receiving layer. Especially when an edge band is used with materials, for example an ABS or a PP, which differs from the materials of the decorative main surface, for example resin impregnated paper, matching of gloss is important.

Preferably applying the print layer comprises digital printing. The digital printing preferably comprises the appliance of an ink, said ink preferably chosen from a water-based ink or a solvent-based ink. Said inks can be curable inks, for example UV curable inks, wherein applying the ink layer than preferably also comprises curing the applied ink. The ink can be an acrylate based ink. The curable inks are preferably radiation-curable, for example by UV radiation or by electron beam (EB) radiation or by light emitting diode (LED). The set of curable inks may preferably comprise acrylic-based inks, for example comprising a blend of different types of acrylate monomers and/or oligomers such as polyester acrylate, polyether acrylate, urethane acrylate, epoxy acrylate, or combinations thereof. Preferably the inks comprise a photo initiator, for example, to activate curing of the ink in presence of a predetermined dose of radiation.

Applying the print layer can be performed in at least two steps, a first step wherein a background color is printed and a second step wherein further colors are printed. This can or cannot be done with the same printer.

Applying the print layer can be done by printing with a CMYK set of colors and/or printing with a CMYK set of inks and a set of extra ink.

Applying the print layer can be done by printing with an inkjet printer.

In a specific embodiment the side edge of the panel unit comprise an edge band, or the second partial step comprises applying an edge band to said side edge, wherein said edge band preferably comprises thermoplastic material such as acrylonitrile butadiene styrene or comprises at least one resin impregnated paper, wherein further preferably the second partial step comprises printing upon said edge band to form said second decor. Said printing can be done directly upon said edge band, but one can also perform additional actions which can be the same as described in the application of the print receiving layer as described above, more specially can be the application of a primer and/or coating and/or varnish and/or lacquer. Also other actions of the second partial step, such as applying a print and applying a protection layer, can be present. The application of said edge band and optionally applying an additional layer, such as a primer/coating/varnish/lacquer, are then preferably part of applying the print receiving layer as described above.

If the edge band comprises at least on resin impregnated paper and the panel unit comprise a particle board, and if one requires additional strength of the decorative side edge, one can consider providing the side edge with additional strength and this for example by inserting a HDF piece in said side edge. Inserting said HDF piece can or cannot be part of the second partial step.

Further preferably the edge band comprises a base color which matches the first decor. As such less ink is needed when printing said edge band. The edge band could also comprise a basic decor which matches the first decor to a certain extend. As such less ink and/or colors are needed when printing said edge band.

Also further preferably printing upon said side edge band is performed according to one of the following:
after applying said edge band to the side edge;
during the application of said edge band to the side edge in such a way that a portion of the edge band is printed after applying said portion to the side edge, or in such a way that a portion of the edge band is printed before applying said portion to the side edge;
before applying said edge band to the side edge;

and wherein preferably applying said edge band and printing upon said edge band is done in the same continuous process. For example this can be done with one machine while transporting the panel unit with a transporting device, such chain transporting device and/or conveying belt. For example said machine can have a gluing device to glue edge band to a said side edge and more downstream, the machine can have a printing device, comprising for example one or more spray heads, to print upon the applied edge band. Further this machine can also comprise the inspection device, said inspection device being located upstream of said printing device and preferably being located upstream of said gluing device. The invention also relates to a machine comprising a said inspection device, a said gluing device and a said printing device and preferably at least a transporting device to transport the panel unit alongside said inspection device, said gluing device and said printing device, said machine being suitable to perform the method of the invention. The application of said edge band and printing upon said edge band can be done with two separate machines. The application of said edge band can even be done manually. If the edge band is printed before applying said edge band to the side edge, care must be taken to apply the edge band correctly/appropriately.

Further preferably when printing upon said side edge band is performed after applying said edge band to the side edge or during the application of said edge band to the side edge in such a way that a portion of the edge band is printed after applying said portion to the side edge, the edge band, at least after applying said edge band, has a height dimension matching the height dimension of the said side edge, and the print width upon the edge band at least matches the height of the edge band and preferably is larger than the height of the edge band such that printing is also performed at the height of the transition of the edge band and the decorative main surface. With the latter, overprinting is created and good matching between the first decor and the second decor can be ensured.

In a specific embodiment the second decor is a textured decor comprising a second structure and wherein preferably also the first decor is a textured decor comprising a first structure, wherein said second structure matches said first structure. Said textured first decor can be created by mechanical embossing, for example by pressing, and/or chemical embossing, for example by digitally structuring. Said textured second decor can be created by mechanical embossing and/or chemical embossing, for example by digitally structuring.

Further preferably the second partial step comprises texturing as such to form the textured second decor. Texturing can be done by mechanical embossing and/or chemical embossing.

In specific embodiments the panel unit comprises a substrate and at least one decorative top layer, wherein said decorative top layer forms said decorative main surface, said substrate preferably being chosen from the group of:
a wood based core, such as a particle board or a wood fiber board;
a mineral based board;
a thermoplastic based board;

and said top layer preferably chosen from the group of:
a top layer comprising one or more resin impregnated paper layers;
a top layer comprising one or more plastic sheets;
a top layer comprising one or more veneer layers;
a top layer comprising a print directly printed upon the substrate.

For example said panel unit is a laminate comprising a woodbased substrate, such as a particle board substrate, an MDF substrate or an HDF substrate, and comprising a top layer and a bottom layer between which the substrate is located. At least said top layer comprising a decorative surface. Said top layer and said bottom layer at least comprise one resin impregnated paper. These laminates can be of the DPL type (direct pressed laminate) or of the HPL type (high pressure laminate). Said top layer then comprises at least one printed paper layer, for example an analog printed paper layer or a digitally printed paper layer, said at least one printed paper layer forming the first decor or at least partially forming the first decor. For example if the first decor is a textured decor, said at least one printed paper layer together with a 3D relief forms the first decor. For example the top layer can comprises a printed paper layer and a wear resistant paper layer on top of the printed paper layer, wherein at least the wear resistant paper layer is mechanically and/or chemically embossed, such that the printed paper layer and the wear resistant layer together form the first decor.

The panel unit can have a thickness from about 2 mm to about 40 mm, preferably from about 6 mm to about 30 mm. The decoration step preferably takes into account said thickness, since this is also the thickness of the said side edges. Said thickness can be preset by for example the operator and/or said thickness can also be acquired in the first partial step.

Preferably the first decor is at least obtained by digital printing.

The invention also relates to a panel-shaped workpiece made by the method of the invention as described above.

A deviating variant of the first aspect invention, is a method for manufacturing a panel-shaped workpiece, such as a countertop, wherein the method comprises the step of providing a panel unit comprising two opposing main surfaces and side edges connecting said two opposing main surfaces, wherein at least one of said main surfaces is provided with a first decor to form a decorative main surface comprising a first decor and wherein the method comprises a decoration step in which at least a part of one of said side edges is provided with a decoration comprising a second decor, to form a decorative side surface, wherein the second decor matches the first decor, wherein said second decor is preferably derived from said first decor or vice versa. Providing said first and second decor can be done simultaneously or at least partially consecutively. Providing said first and second decor is preferably done at least by digital printing and optionally further by digital texturing. Preferably digitally printing is done with the same type of inks as such to have a uniform look for the decorative main surface and the decorative side surface.

The invention, according to a second aspect, relates to a panel-shaped workpiece, such as a countertop, wherein the panel-shaped workpiece comprises two opposing main surfaces and side surfaces connecting said two opposing main surfaces, wherein at least one of said main surfaces is a decorative main surface comprising a first decor and wherein at least one of said side surfaces is a decorative side surface comprising a second decor, wherein the second decor matches the first decor, wherein said decorative side surface exhibits a high degree of continuity with respect to the decorative main surface, for example the first decor having visual elements, for example wood veins if the first decor is a wood decor or veins if the first decor is a stone decor, that appear to be continuous between the first decor and the second decor, and wherein preferably the second decor abuts the first decor. Said panel-shaped workpiece can be manufactured by a method according to the first aspect of the invention. All the features and embodiments described for the first aspect, apply mutatis mutandis to this second aspect, and vice versa, meaning that all features relating to the second aspect, could also apply to the first aspect. This panel-shaped workpiece can have the look of for example solid wood or natural stone, such as marble or granite. The panel-shaped workpiece can have two decorative main surfaces, wherein then preferably the second decor matches with both decorative main surfaces.

Preferably said second decor is derived from said first decor.

The second decor can
comprise a portion of the first decor, or an adjustment, a skewing, or another alteration thereof; and/or
can be a mirror-image of a portion of the first decor, or a portion, an adjustment, a skewing, or another alteration thereof.

The first decor preferably continuous in the second decor as follows:
the first decor comprises a first wood structure with straight grain and the second decor comprises a second wood structure with matching straight grain or matching end grain, wherein at the height of the transition between the decorative main surface and the decorative side surface, wood elements continue as such resembling solid wood; or
the first decor comprises a first stone structure with veins, and the second decor comprises a second stone structure with veins, wherein veins at the height of the transition between the decorative main surface and the decorative side surface continue as such resembling true stone.

In a preferred embodiment the panel-shaped workpiece comprises a substrate and at least one decorative top layer, wherein said decorative top layer forms said decorative main surface, said decorative top layer comprising at least one printed sheet, for example a resin impregnated printed paper sheet or a printed plastic sheet, said at least one printed sheet at least partially forming the first decor and comprising pigments and/or colorants and preferably being digitally printed, and wherein the decorative side surfaces comprises a print comprising the same pigments and/or colorants as the printed sheet, said print at least partially forming the second decor. The look and feel of the decorative main surface can then be the same or at least very similar to the look and feel of the decorative side surface.

In a specific embodiment the panel-shaped workpiece comprises a substrate and at least one decorative top layer, wherein said decorative top layer comprises a print, directly printed upon said substrate, wherein said print at least partially forms the first decor and comprises pigments and/or colorants and is preferably digitally printed, and wherein the decorative side surfaces comprises a print comprising the same pigments and/or colorants as the print of the decorative top layer. With directly printed is indicated that the print is not printed upon a separate sheet, such as printed upon a paper or a plastic sheet, before application upon the substrate. The substrate however, can have undergone a pretreatment as such to improve the printing. For example a primer can be applied upon the substrate before printing the substrate with an ink. The look and feel of the decorative main surface can be the same or at least very similar to the look and feel of the decorative side surface In a preferred embodiment the decorative side surface comprises an edge band, preferably a printed edge band, for example a basic edge band comprising a base color or base decor, and an additional print printed upon said basic edge band.

The edge band can be a printed edge band comprising a print applied upon a basic edge band, wherein this printed edge band further comprises a protection layer, such as a varnish layer or lacquer layer, applied above said print, wherein said protection layer or varnish layer is or is not textured.

The invention, according to a third aspect, relates to a method for manufacturing a panel-shaped workpiece, such as a countertop, the panel-shaped workpiece comprising two opposing main surfaces and side surfaces connecting said two opposing surfaces, wherein the method comprises the step of providing a panel unit comprising two opposing main surfaces, namely a first main surface and a second main surface, and side edges connecting said first and second main surface, wherein at least the first main surface is a decorative main surface comprising a decor and wherein the method comprises a decoration step in which a groove is provided in the panel unit, which groove extends parallel, along and at a distance from a said side edge, wherein said groove opens into the second main surface and divides the panel unit into a first core part comprising a first decor being a part of the decor, and a second core part comprising a second decor being a part of the decor and comprising said last-mentioned side edge, wherein said first core part and said second core part are moved towards each other and attached to each other such the first core part forms said first main surface of the panel-shaped workpiece and comprises the first decor, and the second core part forms a side surface of the panel-shaped workpiece, said side surface being a decorative side surface comprising the second decor.

Since the first and the second decor are part of the same decor of the panel unit, said first and second decor are matching and an aesthetic looking panel-shaped workpiece is obtained. The first core part and the second core part can be attached to each other by gluing these parts together, for example with the aid of an adhesive/glue. Said glue can be a thermosetting glue, such as a melamine resin, an ureaformaldehyde resin, etc. Said glue can also be a hotmelt glue or cold-bonding glue.

The panel-shaped workpiece can have at least one decorative side surface formed by the first aspect of the invention and at least one decorative side surface formed by the third aspect of the invention. For example the panel-shaped workpiece can have a first pair of opposite decorative side surfaces and a second pair of opposite decorative side surfaces, wherein said first pair of opposite decorative side surfaces are formed according to the first aspect of the invention and the second pair of opposite decorative side surface are formed according to the third aspect of the invention.

Preferably the groove is a substantially V-shaped groove. The groove can have a V-shape, or a V-shape having additional connecting elements such as one or more protrusions and/or one or more corresponding indentations.

Further preferably, boundary surfaces on opposite sides of the substantially V-shaped groove are glued to each other for attaching said first core part to said second core part. In a preferred embodiment the panel unit comprises a substrate and at least one decorative top layer attached to said substrate, said decorative top layer forming the first main surface, wherein said groove is at least provided in the substrate and comprises a top part which preferably continuous into a part of the decorative top layer or continuous to a border of the decorative top layer, and wherein said decorative top layer is bended to attach the first and the second core part to each other. Preferably the decorative top layer is bent at the location of the top part of the groove, preferably at the location of the tip of the V-shaped groove. The top part of the groove being the part of the groove located closest to the first main surface.

Further preferably the decorative top layer comprises two or more sublayers, said sublayers comprising at least a decorative sublayer, wherein the top part of the groove is located in the decorative top layer but remote from the decorative sublayer. This allows good bending of the decorative top layer at the height of the top part of the groove.

More preferably the sublayers comprise a basic sublayer located between the substrate and the decorative sublayer, wherein the top part of the groove is located in said basic sublayer.

The invention also relates to a panel-shaped workpiece, such as a countertop, wherein the panel-shaped workpiece comprises two opposing main surfaces and side surfaces connecting said two opposing main surfaces, wherein said panel-shaped workpiece is made according to the third aspect of the invention.

The panel-shaped workpiece, according to all aspects of the invention, preferably comprises a substrate and at least one decorative top layer, wherein said decorative top layer forms said decorative main surface, said substrate preferably being chosen from the group comprising:
a wood based board such as a particle board or a wood fiber board;
a mineral based board;
a thermoplastic based board; and said top layer preferably chosen from the group comprising:
a top layer comprising one or more resin impregnated paper layers;
a top layer comprising one or more plastic sheets;
a top layer comprising one or more veneer layers;
a top layer comprising a print directly printed upon the substrate.

In order to show the features of the invention in more detail, some preferred embodiments are described below by way of example and without being limited thereto, with reference to the accompanying drawings, in which:

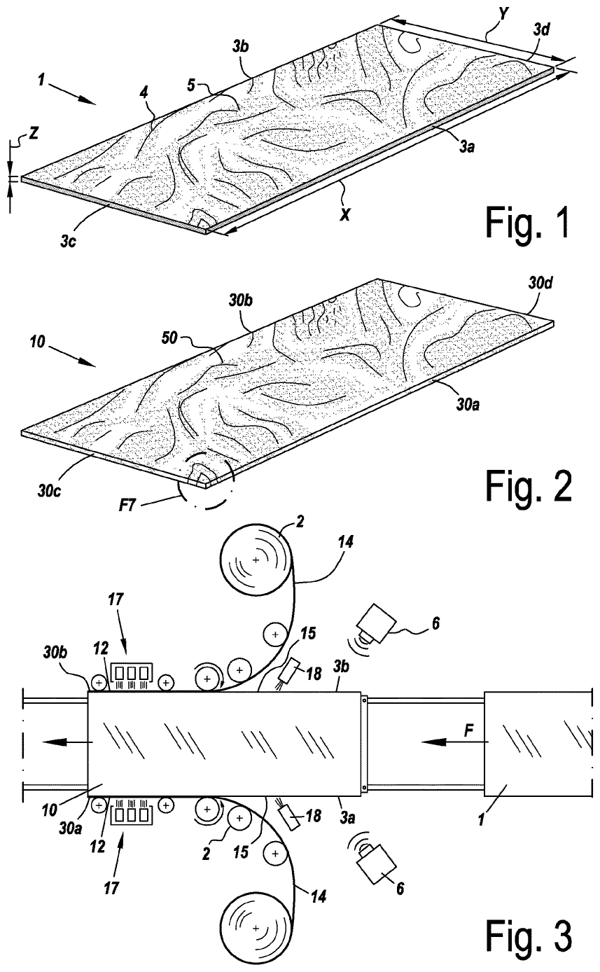

FIG. 1 is a perspective view of a panel unit;

FIG. 2 is a perspective view of a panel-shaped workpiece according to the invention, wherein this panel-shape workpiece can be manufactured from the panel unit of FIG. 1;

FIG. 3 schematically shows a first embodiment of a method according to the first aspect of the invention for manufacturing a panel-shaped workpiece;

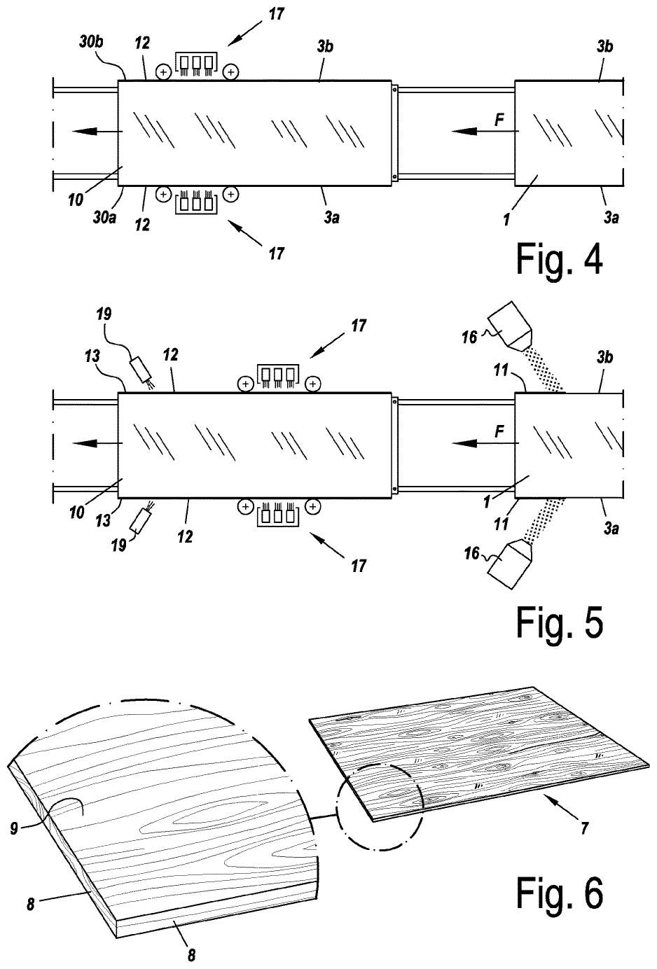

FIG. 4 schematically shows a second embodiment of a method according to the first aspect of the invention for manufacturing a panel-shaped workpiece;

FIG. 5 schematically shows a third embodiment of a method according to the first aspect of the invention for manufacturing a panel-shaped workpiece;

FIG. 6 is a perspective view of a base panel from which a panel unit can be taken;

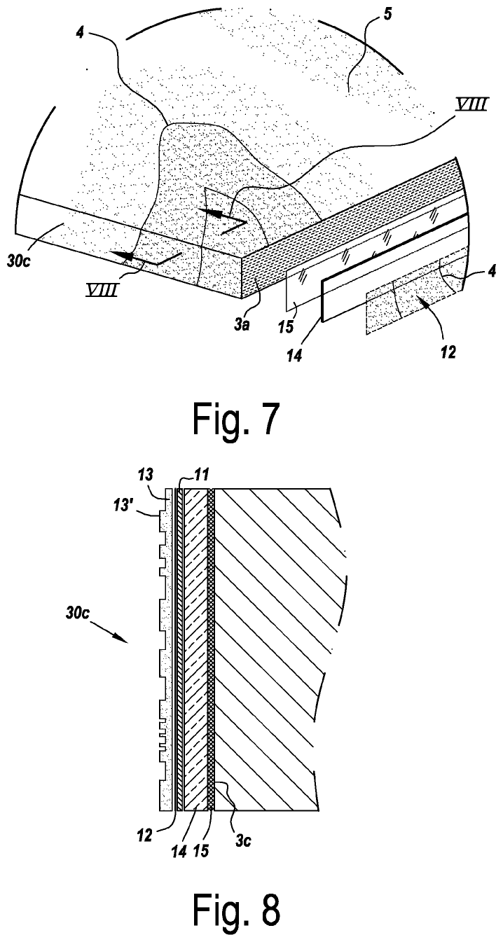

FIG. 7 is a partially exploded view of the part of FIG. 2 indicated by F7;

FIG. 8 is a partial cross section of the part of FIG. 7 indicated by VIII-VIII;

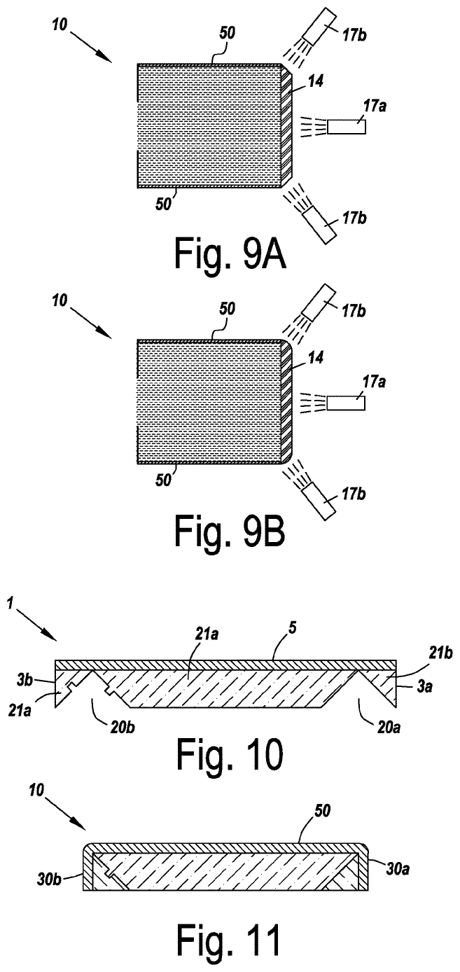

FIGS. 9a and 9b schematically show a possibility for printing upon the edge band of FIG. 3 or FIG. 5 with a specific printing device;

FIG. 10 shows a step of a first embodiment of a method according to the third aspect of the invention for manufacturing a panel-shaped workpiece;

FIG. 11 shows a further step of the first embodiment shown in FIG. 10;

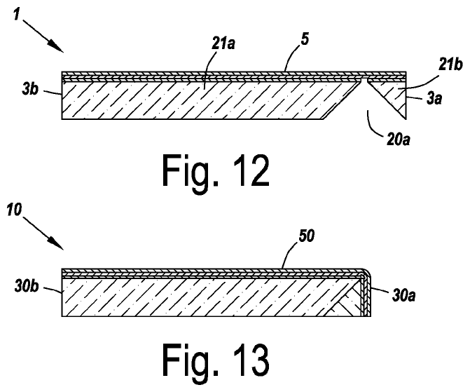

FIG. 12 shows a step of a second embodiment of a method according to the third aspect of the invention for manufacturing a panel-shaped workpiece;

FIG. 13 shows a further step of the second embodiment shown in FIG. 12.

The invention relates to a panel-shaped workpiece 10. This panel-shaped workpiece 10 can for example be used as a countertop for a kitchen. An embodiment of such panel-shaped workpiece 10 is shown in FIG. 2. The panel-shaped workpiece 10 comprises two opposing main surfaces and side surfaces 30a, 30b, 30c, 30d connecting said two opposing surfaces. At least one of said opposing main surfaces is a decorative surface 50 comprising a first decor. The panel-shaped workpiece 10 will be installed in the kitchen in such a way that the at least one decorative surface 50 is the upper surface of the countertop and is thus visible. Both opposite surfaces can be decorative surfaces, however the bottom of a kitchen countertop is not always visible. If the bottom is not visible, the surface that will be present at the bottom of the countertop does not need to be a decorative surface.

The panel-shaped workpiece 10 shown in the figures is a rectangular shaped workpiece 10, more particularly an elongate rectangular shaped workpiece 10. The panel-shaped workpiece 10 has 4 side surfaces 30a, 30b, 30c, 30d. At least some of these side surfaces 30a, 30b, 30c, 30d will be visible during use. At least the visible side surfaces 30a, 30b, 30c, 30d are decorative side surfaces. As can be seen in FIG. 2, at least the side surfaces 30a, 30c visible in FIG. 2 are decorative side surfaces.

A said panel-shaped workpiece 10 can be made according to various embodiments of the invention. Here three embodiments according to the first aspect of the invention are shown in the figures and two embodiments according to the third aspect of the invention.

Preferably one starts from a larger decorative base plate 7. An example of a possible decorative base plate 7 is shown in FIG. 6. Such decorative base plates 7 comprise at least a substrate and a decorative top layer attached to said substrate. Optionally said base plate 7 comprises a (decorative) balance layer attached to the substrate at the opposite side of the decorative top layer. For example this base plate 7 can be or comprise a laminate comprising a wood based substrate, such as a particle board substrate or an MDF/HDF substrate, and a decorative top layer comprising at least one resin impregnated paper and a balancing layer comprising for example at least one resin impregnated paper. The laminate can be of the DPL type (direct pressure laminate), wherein the decorative top layer, the substrate and the balance layer are pressed in one and the same pressing operation. The decorative top layer can then comprise a resin impregnated printed paper comprising a first print (a decor layer) and a resin impregnated translucent/transparent paper (a wear layer) above said decor layer to protect said decor layer. The first print can imitate wood or stone, such as marble or granite. Pressing can be done with press elements, such as press plates, with at least the press element contacting the wear layer preferably being a structured press element, such that the decorative top layer comprises a decorative surface with a structured base decor imitating wood or stone. Pressing can be done in a continuous process or not. The laminate can also be of the HPL type, wherein the decorative top layer is a separate laminate comprising three or more interconnected resin impregnated papers, for example one or more resin impregnated kraft papers, a said decor layer and a said wear layer, wherein said separate laminate is glued upon the substrate with an additional glue layer, as such creating a very robust decorative top layer. Gluing can be done by pressing with at least one structured press element and this to obtain a structured first decor. The result is a laminate having two opposing surfaces, wherein at least one surface 9 comprises a base decor. Said two opposing surfaces are connected by edges. This laminate can form the base plate 7, said base plate 7 not comprising decorative edges. The base plate 7 can also comprise one or more decorative edges 8. For example, the base plate 7 can comprise said laminate, wherein one or more of said edges of the laminate are provided with a decorative edge band or are provided with another decoration, for example a print. Since the base decor is known, matching decorative edge band can be very easily provided. For example after pressing said laminate, edge band can be attached to for example two opposite edges of the laminate in a continuous process, for example when the laminate is being transported on a transporting device, after which the other two opposite edges are or are not provided with edge band. Said edge band can be printed before attaching it to the laminate or after attaching it to the laminate. A said edge band can even be attached to the laminate manually.

As can be seen in FIG. 6, the base plate 7 comprises decorative edges 8. The base decor in FIG. 6 is a wood decor and abutting decorative edges 8 respectively imitate long grain and end grain, as such giving the impression of real wood. Of course, this base plate 7 could also imitate stone. From this base plate 7, rectangular panel units 1 are sawn, and this according to the sawn lines shown in dashed lines. These panel units 1 all comprise two opposing main surfaces, at least one main surface 5 comprising a first decor which is a section of the base decor and four side edges 3a, 3b, 3c, 3d, with at least one decorative side edge which matches the first decor.

FIG. 1 shows a panel unit 1. The panel unit 1 has a length X, a width Y and a thickness Z. This panel unit 1 has two opposing main surfaces, with at least the visible main surface being a decorative main surface 5 having a first decor which imitates a stone decor. This panel unit 1 can be obtained from a base plate 7 as shown in FIG. 6, with the difference that this base plate 7 should imitate a stone decor. The panel unit 1 shown in FIG. 1 has four side edges 3a, 3b, 3c, 3d of which at least the in FIG. 1 visible side edges (3a, 3c) are not decorative. The non-visible side edges (3b, 3d) in FIG. 1 could also be not decorative, but could be decorative. For example if the panel unit 1 shown in FIG. 1 is obtained from a base plate 7 not having decorative edges, then the side edges are also not decorative. If however the panel unit 1 is sawn from a base plate 7 having at least one decorative edge, the panel unit 1 can have at least one decorative side edge.

FIGS. 3, 4 and 5 show possible embodiments to obtain a panel-shaped workpiece 10 as shown in FIG. 2 from for example a panel unit 1 as shown in FIG. 1. FIGS. 10 to 13 show possible embodiments to obtain a panel-shaped workpiece 10 as shown in FIG. 2 from for example a panel unit 1 as shown in FIG. 1.

For the first embodiment shown in FIG. 3, the used panel unit 1 at least has two opposing side edges 3a, 3b which are not decorative. This panel unit 1 is being transported along a direction F according to its length direction with the aid of a transporting device, such as a chain transporting device or a belt conveyor. During its transport, it passes along an inspection device 6, said inspection device 6 at least comprising one camera, preferably at least two cameras'. This inspection device 6 is schematically shown as two cameras, however the inspection device 6 can comprise further units, such as a processing unit, a data storage unit, a scanner unit, etc. This inspection device 6 collects data of the panel unit 1, for example data of the first decor such as images of the first decor and/or date obtained from codes present in the first decor, said data comprising for example information about dimensions X, Y, Z of the panel unit 1. During its transport, the panel unit 1 also passes an application device 18 which applies glue to said two opposing side edges 3a, 3b and this to form a glue layer 15. This application device 18 can be a spraying device, a needle device, a transfer wheel, a transfer roller, a vacumate, etc. The edge band 14 is glued upon the respective side edges 3a, 3b with the aid of an edge band applicator 2, which applies said edge band 14 to said glue layer 15. The edge band 14 can be white, or can have a basic color or a basic decor in line with the first decor, such that less ink is needed to obtain side edges 3a, 3b with the desired look (see further). After the edge band applicator 2, the side edge 3a, 3b with edge band 14 is transported along a printing device 17 comprising for example one or more print heads and this to apply ink upon the edge band 14 and as such forming a print layer 12. The result is a panel-shaped workpiece 10 with at least two decorative side edges 30a, 30b comprising a second decor which matches the first decor, preferably in such a way that visual elements 4 of the first decor, such as veins, continue in a said second decor. Here the inspection device 6 is, according to direction of movement F of the panel unit 1, situated before the application device of glue 18. However this camera can be situated at any location, according to direction of movement F of the panel unit 1, as long as it is before or at the height of the printing device 17, thus for example between the printing device 17 and the edge band applicator 2 or between the edge band applicator 2 or the application device of glue 18 or at the height of the edge band applicator 2 or at the height of the application device of glue 18. FIGS. 9a and 9b schematically shows one possibility for the printing device 17, said printing device 17 can be used in the embodiments shown in FIGS. 3 and 4. The printing device 17 can have print heads 17a perpendicular to the said side edges 3a, 3b. The printing device can have print heads 17b at an angle to said side edges 3a, 3b, and this preferably viewed in a plane perpendicular to panel unit 1, such that also rounded parts and angled/beveled parts of the edge band 14 are printed. Preferably said print heads, or additional print heads, are also capable of printing upon edges of the edge band 14 which extend transversely to the longitudinal direction of the edge band. For this, the printing device 17 can have print heads 17a which operate, viewed in the plane of the panel unit, at angle to the side edge of less than 90°.

In a variant of the first embodiment, the printing device 17 is not present, at least at the location shown in FIG. 3, and the edge band 14 is already provided with the desired second decor when it is glued upon the side edge 3a, 3b. This gives the advantage that only edge band 14 needs to be applied to the said side edges 3a, 3b. This can even be done by hand and/or without the need to transport the panel unit 1 with a transporting device. For example one can obtain data form the panel unit 1, provide this data to a separate device which forms the desired edge band 14, for example prints an edge band with the desired second decor, and then apply the edge band 14 to the panel unit 1.

In FIG. 3, after the edge band applicator 2, only a printing device 17 is shown. However other devices can also be present. For example a primer device 16 to provide a print receiving layer 11, such as an ink receiving layer, upon the edge band 14, said primer device 16 being provided to apply a coating, primer, lacquer, etc. upon the edge band 14 before the print 12 is applied. A protection layer device 19 can also be present, to provide a protection layer 13, 13′ above the print 12 in the form of for example a lacquer, a coating, etc. Said protection layer 13, 13′ can be textured layer and said protection layer device 19 can further comprise texturizers which perform chemical and/or chemical embossing. The protection layer 13, 13′ can have one, two or more sublayers, for example first a lacquer sublayer 13 followed by a coating 13′.

If the other two opposite side surfaces 30c, 30d should also be decorative side surfaces, then said side edges 3c, 3d could already be decorative side edges 3c, 3c or be provided with a decoration in the same manner as the first mentioned opposite side edges 3a, 3b.

The second embodiment shown in FIG. 4, uses a panel unit 1 with at least has two opposing side edges 3a, 3b. Preferably said two opposing side edges 3a, 3b already comprise edge band, said edge band can be white or another color. Preferably this edge band has a base color similar to a color present in the first decor and/or a basic decor similar to the first decor. Instead of edge band, these side edges can already be treated with an ink receiving layer 11, for example a primer or a coating, and/or filler material such that the side edges 3a, 3b are well suited to receive a print 12. This panel unit 1 is being transported along a direction F according to its length direction. The panel unit 1 has been inspected by an inspection device 6, said inspection device 6 comprising for example at least one camera, preferably at least two cameras. The inspection device 6 can comprise further units, such as a processing unit, a data storage unit, a scanner unit, etc. This inspection device 6 collects data of the panel unit 1, for example data of the first decor. The side edge 3a, 3b is transported along a printing device 17 comprising for example one or more print heads and this to apply ink upon the side edges 3a, 3b and as such forming a print layer 12. The result is a panel-shaped workpiece 10 with at least two decorative side surfaces 30a, 30b comprising a second decor which matches the first decor, preferably in such a way that visual elements 4 of the first decor, such as veins, continue in a said second decor.

In FIG. 4, only a printing device 17 is shown. However other devices can also be present. For example a primer device 16 to provide a print receiving layer 11, such as an ink receiving layer, upon the edge band 14, said primer device 16 being provided to apply a coating, primer, lacquer, etc. upon the edge band 14 before the print 12 is applied. A protection layer device 19 can also be present, to provide a protection layer 13, 13′ above the print 12 in the form of for example a lacquer, a coating, etc. Said protection layer 13, 13′ can be textured layer and said protection layer device 19 can further comprise texturizers which perform chemical and/or chemical embossing.

If the other two opposite side surface 30c, 30d should also be decorative side surfaces, then said side edges 3c, 3d could already be decorative side edges 3c, 3c or be provided with a decoration in the same manner as the first mentioned opposite side edges 3a, 3b.

For the third embodiment shown in FIG. 5, the used panel unit 1 at least has two opposing side edges 3a, 3b. Said two opposing side edges 3a, 3b can or cannot comprise edge band, said edge band can be white or another color. Preferably this edge band has a base color similar to a color present in the first decor and/or a basic decor similar to the first decor. The panel unit 1 is transported by a transporting device, such as a chain transporting device, according to direction F along the length direction. The panel unit 1 first passes along a primer device 16 to provide a print receiving layer 11, such as an ink receiving layer, said primer device 16 applying a coating, primer, a filling material and/or lacquer. The panel unit 1 passes along a printing device 17 which applies a print 12 upon the print receiving layer 11 and this to form a print layer 12. Then the panel unit 1 passes along a protection layer device 19 which provides a protection layer 13, 13′ above the print 12 in the form of for example a lacquer and/or coating, etc. Said protection layer 13, 13′ can be textured layer and said protection layer device 19 can further comprise texturizers which perform chemical and/or chemical embossing. The protection layer 13, 13′ can or cannot have two or more sublayers, for example first a lacquer sublayer 13 followed by a coating 13′.

FIG. 7 shows a partially exploded view of a part of the panel-shaped workpiece 10 shown in FIG. 2. FIG. 8 shows a partial cross section of FIG. 7 indicated by VIII-VIII. As can be seen in these figures the panel-shaped workpiece 10 comprises a panel unit 1 comprising two opposite main surfaces, with at least one decorative main surface 5, which also forms the decorative surface 50 of the panel-shaped workpiece 10, and comprising four non decorative side edges 3a, 3b, 3c, 3d. Upon at least two of said side edges, here 3b, 3c, a decoration is applied, said decoration comprising the following layers: a glue layer 15, an edge band 14, a print receiving layer 11, a print layer 12, a protection layer comprising a lacquer layer 13 and a coating 13′. Said lacquer layer 13 is a textured lacquer layer 13 that is for example obtained by applying a UV-curable lacquer, followed by applying anti-curing agents at specific location of said lacquer, curing said lacquer, brushing away the non-cured parts of the lacquer. After texturing, a coating 13′ is applied upon the highest points of the lacquer layer 13.

In FIG. 8 it is clearly shown that the decoration comprising the second decor, can be made up by different layers, here a glue layer 15, an edge band 14, a print receiving layer 11, a print layer 12, a textured lacquer layer 13 and a coating 13′.

For the first embodiment of the third aspect of the invention as shown in FIGS. 10 and 11, the used panel unit 1 at least has two opposing side edges 3a, 3b which can or cannot be decorative. The panel unit 1 has a first decorative main surface 5 and a second main surface which is or is not a decorative surface. This panel unit 1 is provided with two substantially V-shaped grooves 20a, 20b which extends parallel, along and at a distance from said respective side edges 3a, 3b, wherein said grooves 20a, 20b open into the second main surface and divides the panel unit 1 into a first core part 21a comprising a first decor being a part of the decor, a second core part 21b comprising a second decor being a part of the decor and comprising one said side edge 3a, and a third core part 21b comprising a third decor being part of the decor and comprising said other side edge 3b. As can be seen in FIG. 11, said first core part 21a and said second core part 21b have been moved towards each other and have been attached to each other, preferably glued, and said first core part 21a and said second core part 21b have been moved towards each other and have been attached to each other, preferably glued, such the first core part 21a forms the first main surface 50 of the panel-shaped workpiece 10 and comprises the first decor, and the second and third core part 21b form decorative side surfaces 30a, 30b of the panel-shaped workpiece 10. For this the boundary surfaces on opposite sides of the substantially V-shaped grooves 20a, 20b are attached to each other. As can be seen in FIGS. 10 and 11, the panel unit 1 comprises a substrate and one decorative top layer attached to said substrate, said decorative top layer forming the first main surface 5, wherein said grooves 20a, 20b are provided in the substrate, and comprises a top part, a tip, which touches said decorative top layer. Said decorative top layer is bended to attach the said core parts 21a, 21b to each other. FIG. 10 shows two possibilities for the shape of the substantially V-shaped groove 20a, 20b, namely a groove having a V-shape and a groove having a V-shape with an additional protrusion and corresponding indentation on the boundary surfaces on opposite sides. The result is a panel-shaped workpiece 10 with at least two decorative side edges 30a, 30b comprising a second and third decor which matches the first decor, in such a way that visual elements 4 of the first decor, for example veins, continue in a said second and/or third decor.

The second embodiment of the third aspect of the invention as shown in FIGS. 12 and 13, is similar to that of the first embodiment of the third aspect of the invention. A difference is that the top part of the substantially V-shaped grooves 20a, 20b, being the tips, are located in the decorative top layer. As can be seen in FIGS. 12 and 13, the decorative top layer comprises, from bottom to top, three layers, namely a basic sublayer, a decorative sublayer and a protective sublayer. As can be seen in FIGS. 12 and 13 the tip is present in the basic sublayer.

1. A method for manufacturing a panel-shaped workpiece, wherein the method comprises a step of providing a panel unit comprising two opposing main surfaces and side edges connecting said two opposing main surfaces, wherein at least one of said main surfaces is a decorative main surface comprising a first décor, and wherein the method comprises a decoration step in which at least a part of one of said side edges comprises a decoration comprising a second decor, to form a decorative side surface wherein the second decor matches the first decor, wherein said decoration step comprises:
a first partial step wherein an inspection device acquires data of said panel unit;
a second partial step wherein said second decor is derived from said data and said decoration comprising the second decor, is provided upon said side edge.

2. The method according to claim 1, wherein the inspection device at least acquires data of the first decor of said panel unit.

3. The method according to claim 1, wherein the inspection device acquires at least two images of said first decor.

4. The method according to claim 1, wherein the second decor abuts the first decor such that the first decor continues in the second decor, such that visual elements of the first decor, continue in the second decor.

5. The method according to claim 1, wherein the panel unit comprises at least one code which is readable by the inspection device, wherein, to acquire said data, the inspection device reads said code.

6. (canceled)

7. The method according to claim 1, wherein the panel unit is obtained from a base plate, said base plate comprising two opposite surfaces connected by edges, wherein at least one of said two opposite surfaces is a decorative surface comprising a base decor, wherein the first decor is a section of the base decor, and wherein the data comprises information with regard to the first decor.

8. (canceled)

9. The method according to claim 1, wherein deriving the second decor from the data, comprises evaluating said data and determining the required second decor based upon the evaluation of said data.

10. (canceled)

11. (canceled)

12. The method according to claim 1, wherein the second partial step comprises one or more of:
applying a print receiving layer;
applying a print, or a print layer;
applying a protection layer.

13. (canceled)

14. (canceled)

15. (canceled)

16. (canceled)

17. The method according to claim 1, wherein a side edge of the panel unit comprises an edge band, or wherein the second partial step comprises applying an edge band to said side edge, wherein the second partial step comprises printing upon said edge band to form said second decor.

18. (canceled)

19. The method according to claim 9, comprising printing upon said edge band according to one of:
after applying said edge band to the side edge;
during the application of said edge band to the side edge such that a portion of the edge band is printed after applying said portion to the side edge or such that a portion of the edge band is printed before applying said portion to the side edge;
before applying said edge band to the side edge;
and wherein applying said edge band and printing upon said edge band is done in a same continuous process.

20. The method according to claim 9, comprising printing upon said edge band after applying said edge band to the side edge or during the application of said edge band to the side edge in such that a portion of the edge band is printed after applying said portion to the side edge, and wherein, the edge band, at least after applying said edge band, has a height dimension matching a height dimension of the said side edge, and wherein a print width upon the edge band is larger than the height of the edge band such that printing is also performed at a height of a transition of the edge band and the decorative main surface.

21. The method according to claim 1, wherein the second decor is a textured decor comprising a second structure and wherein also the first decor is a textured decor comprising a first structure, wherein said second structure matches said first structure.

22. (canceled)

23. (canceled)

24. (canceled)

25. A panel-shaped workpiece, wherein the panel-shaped workpiece comprises two opposing main surfaces and side surfaces connecting said two opposing main surfaces, wherein at least one of said main surfaces is a decorative main surface comprising a first decor and wherein at least one of said side surfaces is a decorative side surface comprising a second decor, wherein the second decor matches the first decor, wherein the decorative side surface exhibits a high degree of continuity with respect to the decorative main surface, with the first decor having visual elements, that are continuous between the first decor and the second decor, and wherein the second decor abuts the first decor.

26. (canceled)

27. The panel-shaped workpiece of claim 25, wherein the second décor:
comprises a portion of the first decor, or an adjustment, a skewing, or another alteration thereof; and/or
is a mirror-image of a portion of the first decor, or a portion, an adjustment, a skewing, or another alteration thereof.

28. (canceled)

29. The panel-shaped workpiece according to claim 13, wherein the panel-shaped workpiece comprises a substrate and at least one decorative top layer, wherein said decorative top layer forms said decorative main surface, said decorative top layer comprising at least one printed sheet, said at least one printed sheet at least partially forming the first decor and comprising pigments and/or colorants, and wherein the decorative side surface comprises a print comprising pigments and/or colorants identical to those of the printed sheet, said print at least partially forming the second decor.

30. The panel-shaped workpiece according to claim 25, wherein the panel-shaped workpiece comprises a substrate and at least one decorative top layer, wherein said decorative top layer comprises a print, directly printed upon said substrate, wherein said print at least partially forms the first decor and comprises pigments and/or colorants, and wherein the decorative side surfaces preferably comprises a print comprising pigments and/or colorants identical to those of the decorative top layer.

31. (canceled)

32. (canceled)

33. (canceled)

34. A method for manufacturing a panel-shaped workpiece, the panel-shaped workpiece comprising two opposing main surfaces and side surfaces connecting said two opposing main surfaces, wherein the method comprises a step of providing a panel unit comprising two opposing main surfaces, including a first main surface and a second main surface, and side edges connecting said first and second main surface, wherein at least the first main surface is a decorative main surface comprising a decor and wherein the method comprises a decoration step in which a groove is provided in the panel unit, which groove extends parallel, along and at a distance from a said side edge, wherein said groove opens into the second main surface and divides the panel unit into a first core part comprising a first decor being a part of the decor, and a second core part comprising a second decor being a part of the decor and comprising said last-mentioned side edge, wherein said first core part and said second core part are moved towards each other and attached to each other such the first core part forms the first main surface of the panel-shaped workpiece and comprises the first decor, and the second core part forms a side surface of the panel-shaped workpiece, said side surface being a decorative side surface comprising the second decor.

35. The method according to claim 17, wherein the groove is substantially a V-shaped groove.

36. The method according to claim 35, wherein boundary surfaces on opposite sides of the substantially V-shaped groove are glued to each other for attaching said first core part to said second core part.

37. The method according to claim 17, wherein the panel unit comprises a substrate and at least one decorative top layer attached to said substrate, said decorative top layer forming the first main surface, wherein said groove is at least provided in the substrate, and comprises a top part which is continuous into a part of the decorative top layer or continuous to a border of the decorative top layer, and wherein said decorative top layer is bended to attach the first core part and the second core part to each other.

38. (canceled)

39. (canceled)

40. (canceled)
